(19) United States
(12) Patent Application Publication
(10) Pub. No.: US 2017/0067228 A1
(43) Pub. Date: Mar. 9, 2017

(54) SYSTEM FOR APPLYING BRAKE TORQUE ON WHEEL OF MACHINE

(71) Applicant: Caterpillar Inc., Peoria, IL (US)

(72) Inventor: Brandon L. Hagman, Decatur, IL (US)

(73) Assignee: Caterpillar Inc., Peoria, IL (US)

(21) Appl. No.: 15/357,040

(22) Filed: Nov. 21, 2016

(51) Int. Cl. E02F 9/20; B60T 7/04

(52) U.S. Cl. CPC E02F 9/2083; B60T 7/042

(57) ABSTRACT

A system for applying brake torque on a wheel of a machine includes a housing member and a spindle coupled to the housing member. A mounting member is coupled to the spindle, and coupled to a brake disc and a rim of the wheel. A caliper is coupled to the housing member and selectively engages with the brake disc. A control valve is in fluid communication with the caliper and a controller of the machine. The controller determines the positon of the brake pedal based on signals received from a first sensor and generates a first output signal when the position of the brake pedal is beyond a threshold position. Further, the controller communicates the first output signal with the control valve to allow flow of fluid into the caliper. The caliper engages with the brake disc to apply the brake torque on the wheel.

### TECHNICAL FIELD

The present disclosure relates to braking of a machine, and more particularly to a system for applying brake torque on a wheel of the machine.

### BACKGROUND

Machine, such as a motor grader, includes a front frame and a rear frame pivotably coupled with the front frame. The front frame is provided with an axle for supporting traction devices, such as wheels, and the rear frame is provided with a pair of axles for supporting wheels to propel the machine over a ground surface. Generally, the motor grader may be required to halt at a short distance upon actuation of a braking system while carrying out operations at a worksite. The braking system is provided at rear wheels to apply brake torque on rear wheels and hence to control movement of the motor grader over the ground surface. However, the braking system provided at the rear wheels may not provide required braking effect within the short distance.

U.S. Pat. No. 8,844,278, hereinafter referred to as the '278 patent, describes a control system and method for controlling an electrohydraulic charging system. The '278 patent discloses front and rear brakes, each of which includes a hydraulic pressure-actuated wheel brake, such as, a disk brake. When actuated, pressurized fluid within the front and rear brakes increases the rolling friction of a machine and thus retards the movement of the machine. As an operator depresses the brake pedal, pressurized fluid is directed to the front and rear brakes such that a degree of brake pedal depression controls a flow of pressurized fluid that is supplied to the front and rear brakes. However, the '278 patent fails to disclose braking system that provides desired braking effort within a short distance to halt the machine.

### SUMMARY OF THE DISCLOSURE

In an aspect of the present disclosure, a system for applying brake torque on a wheel of a machine is provided. The system includes a housing member mounted on an axle of the machine. The axle is adapted to rotatably support the wheel. The system further includes a spindle that is rotatably coupled to the housing member. The system further includes a mounting member coupled to the spindle, and adapted to couple to a brake disc and the wheel. The system also includes a caliper coupled to the housing member, and adapted to selectively engage with the brake disc. The system further includes a control valve in fluid communication with the caliper, and adapted to control an operation of the caliper based on depression of a brake pedal of the machine. The system further includes a first sensor disposed proximal to the brake pedal, and configured to generate signals indicative of a position of the brake pedal. The system also includes a controller in electronic communication with the first sensor and the control valve. The controller is configured to determine the positon of the brake pedal based on the signals received from the first sensor. The controller is further configured to generate a first output signal when the position of the brake pedal is beyond a threshold position. Further, the controller is configured to communicate the first output signal with the control valve to allow flow of fluid into the caliper or drain back out of the caliper when the control valve is released. The caliper engages with the brake disc to apply the brake torque on the wheel.

### BRIEF DESCRIPTION OF THE DRAWINGS

FIG. 1 is a perspective view of a motor grader having a system disposed at a front axle for applying brake torque on wheels:

FIG. 2 is a cut sectional view showing a caliper and a brake disc of the system associated with a wheel of the motor grader;

FIG. 3 is a schematic block diagram of the system for applying brake torque on the wheels of the motor grader;

FIG. 4 is a flow chart of a method of applying brake torque on the wheels of the motor grader, according to one embodiment of the present disclosure; and

FIG. 5 is a flow chart of a method of applying brake torque on the wheels of the motor grader, according to another embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature.

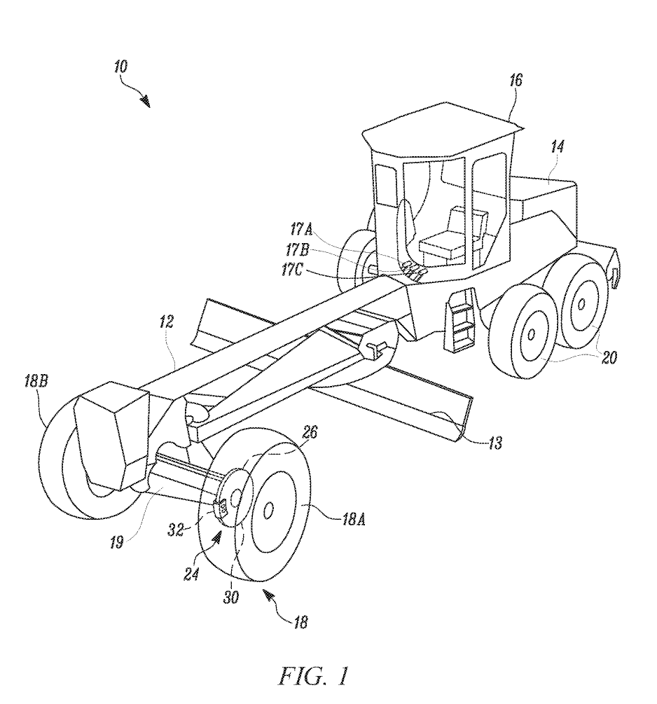

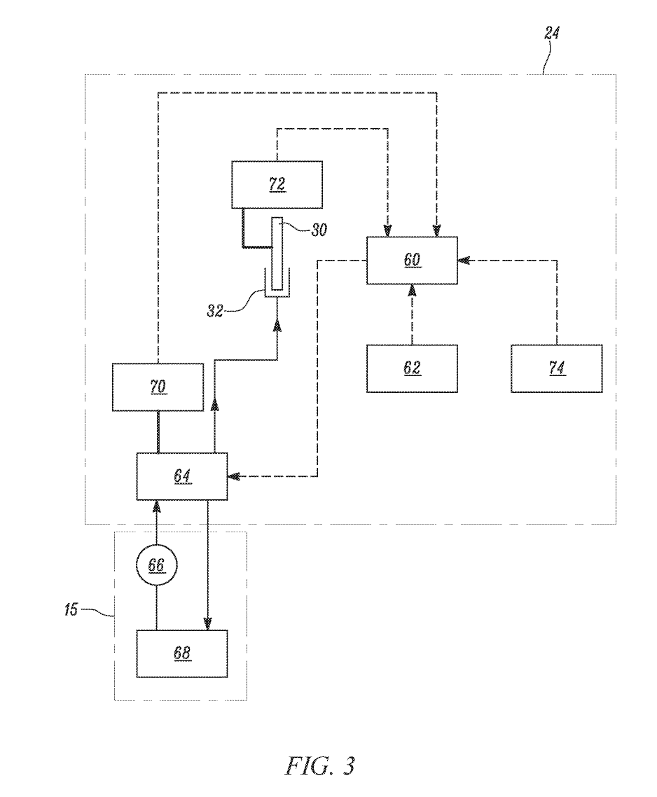

Referring to FIG. 1, a perspective view of a machine 10, such as a motor grader, is illustrated. In various examples, the machine 10 may be associated with an industry, such as mining, construction, farming, transportation, or any other industry known in the art. The machine 10 is hereinafter referred to as ‘the motor grader 10’. The motor grader 10 includes a front frame 12 and a rear frame 14 pivotably coupled with the front frame 12. The motor grader 10 further includes an engine (not shown) disposed in the rear frame 14. The rear frame 14 also houses various operating systems, such as a transmission system (not shown) and a hydraulic system 15 (shown in FIG. 3), which receive a driving power from the engine. The motor grader 10 further includes an operator cab 16 containing input devices and operator interfaces, such as a brake pedal 17B, a clutch pedal 17C and an accelerator pedal 17A, disposed at the front frame 12. In an example, the input devices may include control levers and buttons (not shown) disposed within the operator cab 16 for controlling operation of a work tool 13 supported in the front frame 12.

The motor grader 10 further includes a first set of wheels 18 rotatably coupled to an axle 19, which in turn is pivotably coupled to the front frame 12. The first set of wheels 18 includes a first wheel 18A coupled to one end of the axle 19 and a second wheel 18B coupled to another end of the axle 19. The motor grader 10 further includes a second set of wheels 20 rotatably coupled to the rear frame 14. The engine provides a motive power to the second set of wheels 20 via the transmission system. The first set of wheels 18 and the second set of wheels 20 are used for steering and propelling the motor grader 10 in forward and reverse directions.

The motor grader 10 further includes a system 24 for applying brake torque on the first set of wheels 18 during operation of the motor grader 10. More specifically, the system 24 applies the brake torque on the first wheel 18A and the second wheel 18B of the first set of wheels 18 based on an input received by the brake pedal 17B from an operator of the motor grader 10. The first wheel 18A and the second wheel 18B are associated with a first brake 26 and a second brake (not shown), respectively. Each of the first brake 26 and the second brake includes a brake disc 30 and a caliper 32 for applying the brake torque on the first wheel 18A and the second wheel 18B. The brake torque applied on the first set of wheels 18 reduces a speed of the motor grader 10. The brake torque applied on the first set of wheels 18 in addition to brake torque applied on the second set of wheels 20 causes the motor grader 10 to halt within a short distance upon depression of the brake pedal 17B. Construction and mounting arrangement of the first brake 26 and the second brake in association with the first wheel 18A and the second wheel 18B, respectively, will be described hereinbelow. For illustration purpose of the present disclosure, the first brake 26 coupled to the first wheel 18A, hereinafter referred to as ‘the wheel 18A’, of the first set of wheels 18A is explained in detail.

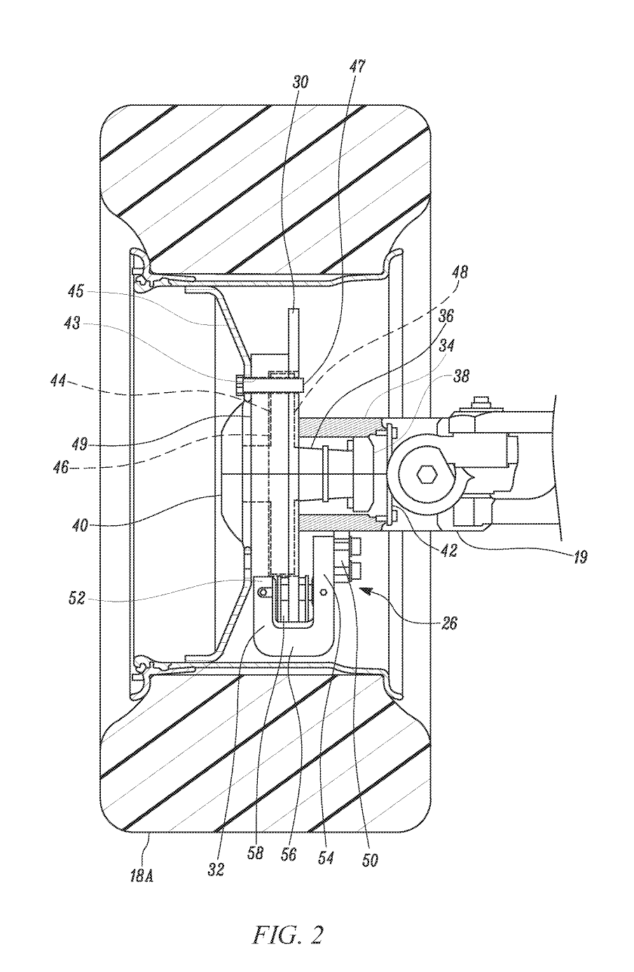

Referring to FIG. 2, mounting of the brake disc 30 and the caliper 32 with the wheel 18A is illustrated. The system 24 includes a housing member 34 mounted on the axle 19 of the motor grader 10. The housing member 34 is pivotably coupled to the axle 19 and includes multiple mounting members for connecting with a track rod (not shown) and a hydraulic cylinder (not shown). The hydraulic cylinder enables movement of the wheel 18A at various steering angle with respect to the axle 19. A spindle 36 is rotatably coupled to the housing member 34. The spindle 36 disposed within the housing member 34 rotatably supports the wheel 18A. More specifically, the spindle 36 is a solid shaft having a first end 38 and a second end 40 rotatably supported within the housing member 34 via bearing assemblies. More specifically, the first end 38 is supported by a bracket 42 within the housing member 34 and the second end 40 is coupled to a mounting member 44. In one example, the mounting member 44 is coupled to the spindle 36 by fastening members, such as bolts and nuts. In another example, the mounting member 44 may be an integral component of the spindle 36. In yet another example, the mounting member 44 may be welded to the second end 40 of the spindle 36. The mounting member 44 is a disc shaped component having a first face 46 facing away from the housing member 34 and a second face 48 facing towards the housing member 34. The mounting member 44 further includes a plurality of through holes 43 defined along an annular periphery thereof. The mounting member 44 is coupled with the brake disc 30 and a rim 45 of the wheel 18A. More specifically, the first face 46 of the mounting member 44 is coupled with the brake disc 30 by inserting fastening members 47 through the plurality of through holes 43 of the mounting member 44. Further, the rim 45 of the wheel 18A is disposed over an outer face 49 of the brake disc 30 and coupled with the mounting member 44 by inserting the fastening members 47 through a plurality of holes defined in the brake disc 30 and the plurality of through holes 43 of the mounting member 44.

The housing member 34 of the system 24 further includes a bracket 50 for coupling with the caliper 32 by fastening members such as bolts and nuts. The caliper 32 is a C-shaped structure and extends over an annular periphery of the brake disc 30. The C-shaped structure of the caliper 32 includes an outboard leg 52 distal to the housing member 34 and an inboard leg 54 proximal to the housing member 34. The outboard leg 52 defines a cylinder (not shown) in which a piston (not shown) is slidably received. A caliper bridge 56 extends between the outboard leg 52 and the inboard leg 54. The inboard leg 54 defines another cylinder (not shown) in which a piston (not shown) is slidably received. A thickness of the mounting member 44 is defined in such a way that the outboard leg 52 of the caliper 32 is received within the rim 45 of the wheel 18A and the brake disc 30. The caliper 32 further includes floating brake pads 58 and each of the floating brake pads 58 is disposed adjacent to the outboard leg 52 and the inboard leg 54. A thickness of the brake disc 30 is defined in such a way that the brake disc 30 is movably received within the brake pads 58 disposed adjacent to the outboard leg 52 and the inboard leg 54. Further, the brake pad 58 disposed adjacent to the inboard leg 54 is coupled to the pistons disposed within the cylinder of the caliper 32. The pistons are actuated by the hydraulic system 15 of the motor grader 10 to apply the brake torque on the brake disc 30. The brake torque is applied via the pressure applied by the hydraulic fluid on the brake pads 58. Thus, the caliper 32 selectively engages with the brake disc 30 based on the depression of the brake pedal 17B by the operator.

FIG. 3 is a schematic block diagram of the system 24 for applying the brake torque on the wheel 18A of the motor grader 10. The system 24 includes a controller 60 that is in electronic communication with the various systems, such as the engine system (not shown), the transmission system and the hydraulic system 15, of the motor grader 10 and the various input devices. In an example, the controller 60 may include a microprocessor (not shown) for executing programs in order to control various functions of the engine, the transmission system, the hydraulic system 15 and other components of the motor grader 10. The controller 60 is configured to determine various parameters related the motor grader 10 such as a speed of the motor grader 10. Moreover, the controller 60 is communicably coupled to various sensors associated with the various systems of the motor grader 10, which will be discussed hereinbelow.

The system 24 further includes a first sensor 62 disposed within the operator cab 16 proximal to the brake pedal 17B. The first sensor 62 generates signals indicative of the position of the brake pedal 17B. More specifically, the first sensor 62 detects a depressed position of the brake pedal 17B with reference to a normal position of the brake pedal 17B. In an example, the first sensor 62 may be mounted on the brake pedal 17B. In another example, the first sensor 62 may be disposed at any location within the operator cab 16 to detect the depressed position of the brake pedal 17B. The first sensor 62 is in electronic communication with the controller 60. The controller 60 receives the signals generated by the first sensor 62 and determines an input value corresponding to the depressed position of the brake pedal 17B.

The system 24 further includes a control valve 64 in fluid communication with the caliper 32 and a hydraulic pump 66 of the hydraulic system 15. The hydraulic pump 66 is in fluid communication with a hydraulic tank 68 containing fluid therein. The control valve 64 is also in communication with the hydraulic tank 68 such that unused fluid and/or spilled fluid are returned to the hydraulic tank 68. In addition, the control valve 64 enables the fluid that exerts pressure on the caliper 32 to return from the caliper 32 to the hydraulic tank 68 when the braking is reduced or released. The control valve 64 selectively allows and controls flow and pressure of the fluid into the caliper 32 based on the depression of the brake pedal 17B and hence operates the caliper 32 to engage with the brake disc 30. The control valve 64 is an electrohydraulic valve and is in electronic communication with the controller 60. The control valve 64 is configured to receive a current signal from the controller 60. Upon receipt of the current signal, the control valve 64 allows the fluid to pass therethrough based on various parameters, such as an ampere rating of the current signal. A flow rate and a pressure of the fluid flowing through the control valve 64 are controlled based on the current signal received from the controller 60.

In order to slow down or stop the motor grader 10, the operator pushes the brake pedal 17B. Upon pushing the brake pedal 17B, the first sensor 62 generates the signals indicating the depressed position of the brake pedal 17B. The controller 60 receives the signals and processes the signals to determine the input value corresponding to the depressed position of the brake pedal 17B. The controller 60 further generates a first output signal when the depressed position of the brake pedal 17B is beyond a threshold position. In an example, the threshold positon may be defined as a position of the brake pedal 17B, at which the second set of wheels 20 provide desired brake torque to halt the motor grader 10 within the required short braking distance. Beyond the threshold position of the brake pedal 17B, the second set of wheels 20 alone may not be able bring the motor grader 10 to halt within a desired short braking distance at a desired speed of the motor grader 10. Further, the threshold position may be defined based on a play/clearance provided in the brake pedal linkages.

In another example, the threshold position of the brake pedal 17B may be defined based on a relationship between a speed of the motor grader 10 and a braking distance corresponding to the speed of the motor grader 10. Alternatively, the controller 60 generates the first output signal when the input value corresponding to the depressed position of the brake pedal 17B is greater than a value corresponding to the threshold position. The first output signal, alternatively referred as the current signal, is then communicated with the control valve 64 to allow flow of the fluid into the caliper 32. The pressurized fluid is further received within the cylinders defined on each side of the disc brake 30 within the outboard leg 52 and the inboard leg 54 of the caliper 32 and moves the piston along with the brake pads 58 towards the brake disc 30. Thus, the caliper 32 engages the brake pads 58 with the brake disc 30 to apply the brake torque on the wheel 18A.

In another embodiment of the present disclosure, the system 24 includes a second sensor 70 located proximal to the caliper 32. In an example, the second sensor 70 may be disposed in a fluid line that is in communication with the caliper 32 and the hydraulic pump 66 of the hydraulic system 15. The second sensor 70 is configured to generate signals indicative of a pressure of the fluid flowing into the caliper 32. The second sensor 70 is also in electronic communication with the controller 60. The controller 60 is configured to receive the signals generated by the second sensor 70 and determine a value corresponding to a pressure of the fluid flowing into the caliper 32. During braking of the motor grader 10, the first sensor 62 generates the signals indicative of the depressed position of the brake pedal 17B. The controller 60 further generates the first output signal that is communicated with the control valve 64 to allow flow of the fluid into the caliper 32. Simultaneously, the second sensor 70 generates the signals indicative of the pressure of the fluid flowing into the caliper 32. The signals indicative of an actual pressure of the fluid flowing into the caliper 32 generated by the second sensor 70 are received by the controller 60. The controller 60 further compares the actual pressure of the fluid flowing into the caliper 32 with a desired pressure of the fluid to be supplied into the caliper 32 corresponding to the depressed position of the brake pedal 17B.

The desired pressure of the fluid is determined based on a comparison of the input value corresponding to the depressed position of the brake pedal 17B with a set of predefined values. The set of predefined values is a test lab data and/or a historical data stored in the controller 60. The set of predefined values include multiple input values corresponding to the depressed position of the brake pedal 17B and corresponding pressure of the fluid to be supplied to the caliper 32. In an example, the set of predefined values may be stored in the controller 60 in the form of look up table or graph. In another example, a mathematical relationship may be defined between an input value corresponding to the depressed position of the brake pedal 17B and the corresponding pressure of the fluid to be supplied to the caliper 32. The controller 60 is configured to determine the desired pressure of the fluid based on the input value corresponding to the position of the brake pedal 17B. Further, the controller 60 adjusts the first output signal based on the comparison of the actual pressure of the fluid with the desired pressure of the fluid. In an example, ampere rating of the first output signal is increased if the actual pressure of the fluid is less than the desired pressure of the fluid. Similarly, if the actual pressure of the fluid is greater than the desired pressure of the fluid, then the ampere rating of the first output signal is decreased. The controller 60 further communicates the adjusted first output signal to the control valve 64 to control the flow rate and pressure of the fluid supplied to the caliper 32.

The system 24 further includes a third sensor 72 disposed on the spindle 36. The third sensor 72 is configured to generate signals indicative of the speed of the wheel 18A. In an example, the third sensor 72 may be disposed at any location in the wheel 18A, the spindle 36 or the housing member 34 to generate the signals indicative of the speed of the wheel 18A. The system 24 also includes a fourth sensor 74 configured to generate signals indicative of a speed of the motor grader 10 and the speed of the second set of wheels 20. In an example, the fourth sensor 74 may be disposed at any location in the front frame 12 and/or the rear frame 14 of the motor grader 10 to generate signals indicative of the speed of the motor grader 10. The third sensor 72 and the fourth sensor 74 are in electronic communication with the controller 60.

During the operation of the motor grader 10 and application of the brake torque on the wheel 18A, the controller 60 determines the speed of the wheel 18A based on the signals received from the third sensor 72. Simultaneously, the controller 60 determines the speed of the motor grader 10 based on the signals received from the fourth sensor 74. The controller 60 further compares the speed of the wheel 18A with the speed of the motor grader 10. The controller 60 further generates a second output signal based on the comparison of the speed of the wheel 18A with the speed of the motor grader 10. More specifically, if the speed of the wheel 18A is less than the speed of the motor grader 10 and the wheel 18A is locked due to the application of brake torque, then the controller 60 communicates the second output signal to the control valve 64 to reduce flow of fluid into the caliper 32, such that the caliper 32 disengages from the brake disc 30 to allow the rotation of the wheel 18A.

In another embodiment, the brake disc 30 may be a flat plate coupled to the second face 48 of the mounting member 44 by inserting the fastening members 47 through the plurality of first through holes 43 defined in the mounting member 44. Further, the rim 45 of the wheel 18A may be coupled to the first face 46 of the mounting member 44 by inserting the fastening members 47 through the plurality of second through holes 43 defined in the mounting member 44. In yet another embodiment of the present disclosure, a pair of mounting members (not shown) may be coupled to the spindle 36. One mounting member of the pair of mounting members may be coupled to the spindle 36 proximal to the housing member 34, which in turn is coupled with the brake disc 30. The caliper 32 may be disposed over the annular periphery of the brake disc 30 and coupled to the housing member 34. Another mounting member of the pair of mounting members may be disposed on the spindle 36 away from the housing member 34 and coupled to the spindle 36, which in turn is coupled with the rim 45 of the wheel 18A. Similar brake arrangement may be provided in the second wheel 18B of the first set of wheels 18.

In yet another embodiment of the present disclosure, a mechanically actuated hydraulic valve (not shown), otherwise referred as ‘the manual valve’, may be disposed within the operator cab 16 and coupled with the brake pedal 17B. The manual valve may be in communication with the hydraulic system 15 of the motor grader 10 and the caliper 32. Upon depression of the brake pedal 17B, the manual valve may allow flow of fluid to the caliper 32 at a desired flow rate and at a desired pressure based on the depressed position of the brake pedal 17B. Upon receipt of the pressurized fluid, the caliper 32 engages with the brake disc 30 and applies the brake torque on the first set of wheels 18.

### INDUSTRIAL APPLICABILITY

The present disclosure relates to the system 24 and a method for applying the brake torque on the wheel 18A of the motor grader 10. The system 24 includes the housing member 34 coupled to the axle 19 of the motor grader 10, the spindle 36 rotatably disposed within the housing member 34, and the mounting member 44 coupled to the spindle 36. The system 24 also includes the caliper 32 having the brake pads 58 coupled to the housing member 34 and disposed over the annular periphery of the brake disc 30 to apply brake torque on the brake disc 30 upon depression of the brake pedal 17B by the operator. The system 24 also includes the control valve 64 to allow the flow of fluid into the caliper 32 based on the first output signal received from the controller 60. The controller 60 is in communication with the first sensor 62, the second sensor 70, the third sensor 72 and the fourth sensor 74 to generate the first output signal to allow flow of fluid into the caliper 32 and the second output signal to reduce flow of fluid into the caliper 32. The system 24 of the present disclosure provides effective braking of the first set of wheels 18 in addition to the braking arrangement provided in the second set of wheels 20. Thus, the motor grader 10 can be halted at a short braking distance at any speed thereof with the implementation of the system 24 of the present disclosure.

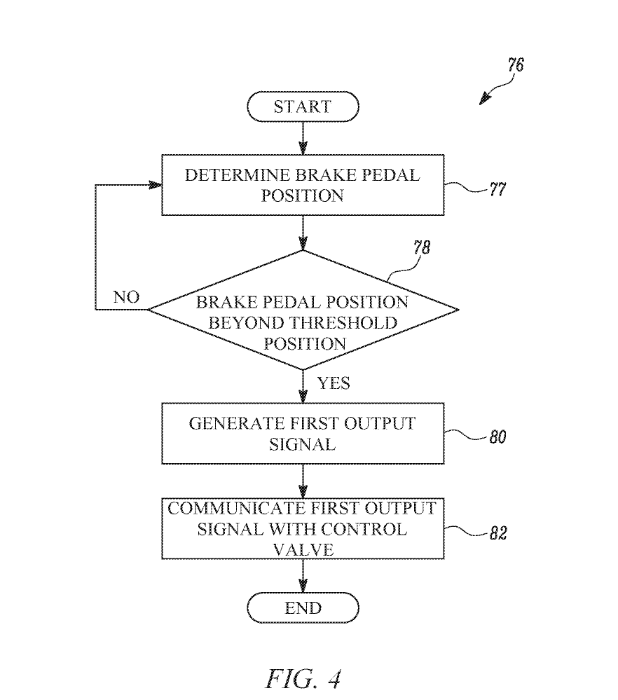

FIG. 4 illustrates a flowchart of a method 76 for applying the brake torque on the wheel 18A of the motor grader 10. The operator pushes the brake pedal 17B to reduce the speed of the motor grader 10 or to halt the motor grader 10. At step 77, the controller 60 determines the depressed position of the brake pedal 17B based on the signals received from the first sensor 62. At step 78, the controller 60 compares the depressed position of the brake pedal 17B with the threshold position and determines if the brake pedal 17B is beyond the threshold position. At step 80, the controller 60 generates the first output signal, when the depressed position of the brake pedal 17B is beyond the threshold position. If the depressed positions of the brake pedal 17B is within the threshold position, then the controller 60 keeps on comparing the position of the brake pedal 17B with the threshold position. At step 82, the first output signal generated by the controller 60 is communicated with the control valve 64 to allow the flow of fluid into the caliper 32 to apply the brake torque on the wheel 18A.

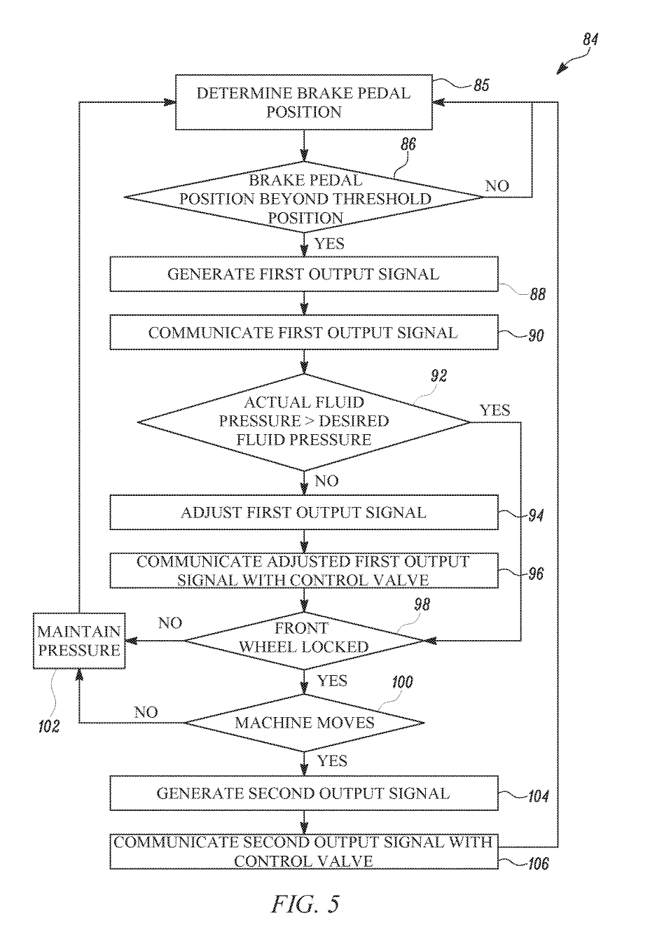

FIG. 5 illustrates a flow chart of a method 84 of applying the brake torque on the wheel 18A. The operator pushes the brake pedal 17B. At step 85, the controller 60 determines the depressed position of the brake pedal 17B based on the signals received from the first sensor 62. At step 86, the controller 60 compares the depressed position of the brake pedal 17B with the threshold position. At step 88, if the depressed position of the brake pedal 17B is beyond the threshold position, then the controller 60 generates the first output signal. At step 90, the first output signal is communicated with the control valve 64 to allow the flow of fluid into the caliper 32. At step 92, the controller 60 determines the actual pressure of the fluid flowing into the caliper 32, based on the signals received from the second sensor 70. Further, the actual pressure of the fluid is compared with the desired pressure of the fluid. At step 94, if the actual pressure of the fluid is less than the desired pressure, then the controller 60 adjusts the first output signal. At step 96, the adjusted first output signal is communicated with the control valve 64 to increase the pressure and flow rate of the fluid supplied to the caliper 32.

At step 92, if the actual pressure of the fluid is greater than the desired pressure of the fluid, then, at step 98, the controller 60 determines the speed of the wheel 18A and check if the wheel 18A is locked. The speed of the wheel 18A is determined based on the signals received from the third sensor 72. At step 100, the controller 60 determines the speed of the motor grader 10 based on the signals received from the fourth sensor 74, if the wheel 18A is locked.

At step 102, if the controller 60 determines that the wheel 18A is not locked due to the application of brake torque and the motor grader 10 is not moving, then the pressure of the fluid within the caliper 32 is maintained. At step 104, the controller 60 compares the speed of the wheel 18A and the speed of the motor grader 10 to determine if the motor grader 10 is moving when the brake pedal 17B is deployed. Further, if the controller 60 detects that the wheel 18A is locked or the speed of the wheel 18A is less than the speed of the motor grader 10, then the controller 60 generates the second output signal. At step 106, the second output signal is communicated with the control valve 64 to reduce the flow and pressure of the fluid into the caliper 32 to disengage the brake pads 58 from the brake disc 30 to allow the rotation of the wheel 18A.

While aspects of the present disclosure have been particularly shown and described with reference to the embodiments above, it will be understood by one skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for applying brake torque on a wheel of a machine, the system comprising:
a housing member mounted on an axle of the machine, the axle adapted to rotatably support the wheel;
a spindle rotatably coupled to the housing member;
a mounting member coupled to the spindle, and adapted to couple to a brake disc and the wheel;
a caliper coupled to the housing member, and adapted to selectively engage with the brake disc;
a control valve in fluid communication with the caliper, and adapted to control an operation of the caliper based on depression of a brake pedal of the machine;
a first sensor disposed proximal to the brake pedal, and configured to generate signals indicative of a position of the brake pedal; and
a controller in electronic communication with the first sensor and the control valve, the controller configured to:
determine the positon of the brake pedal based on the signals received from the first sensor;
generate a first output signal when the position of the brake pedal is beyond a threshold position; and
communicate the first output signal with the control valve to allow flow of fluid into the caliper, wherein the caliper engages with the brake disc to apply the brake torque on the wheel.

2. The system of claim 1 further comprising a second sensor configured to generate signals indicative of a pressure of fluid flowing into the caliper, and in electronic communication with the controller, the controller configured to:
determine an actual pressure of the fluid flowing into the caliper based on the signals received from the second sensor;
compare the actual pressure of the fluid with a desired pressure of the fluid to be supplied into the caliper at the position of the brake pedal, wherein the desired pressure of the fluid is determined based on a comparison of an input value corresponding to the position of the brake pedal with a set of predefined values;
adjust the first output signal based on the comparison of the actual pressure of the fluid with the desired pressure of the fluid; and
communicate the adjusted first output signal with the control valve to control flow of fluid into the caliper.

3. The system of claim 1 further comprising:
a third sensor configured to generate signals indicative of a speed of the wheel; and
a fourth sensor configured to generate signals indicative of a speed of the machine, wherein the third sensor and the fourth sensor are in electronic communication with the controller, the controller configured to:
determine the speed of the wheel based on the signals received from the third sensor;
determine the speed of the machine based on the signals received from the fourth sensor;
compare the speed of the wheel with the speed of the machine;
generate a second output signal if the speed of the wheel is less than the speed of the machine or the wheel is locked; and
communicate the second output signal with the control valve to reduce flow of fluid into the caliper, wherein the caliper disengages from the brake disc to allow rotation of the wheel.
